(19) United States
(12) Patent Application Publication
(10) Pub. No.: US 2011/0029437 A1
(43) Pub. Date: Feb. 3, 2011

(54) Information System, Processing Station and Credit Card Payment Method

(75) Inventor: Cheng-I Lee, Hsinchu (TW)

Correspondence Address: BAKER & MCKENZIE LLP;PATENT DEPARTMENT, 2001 ROSS AVENUE, SUITE 2300, DALLAS, TX, 75201, US

(73) Assignee: HSINCHU TRANSPORT CO., LTD., Hsinchu (TW)

(21) Appl. No.: 12/784,935

(22) Filed: May 21, 2010

(30) Foreign Application Priority Data
Jul. 31, 2009 (TW) 098125980

(51) Int. Cl. H04L 9/32; G06Q 30/00; G06Q 40/00; G06K 7/10

(52) U.S. Cl. 705/72; 705/75; 235/462.13

(57) ABSTRACT

Disclosed are an information system, processing station and credit card payment method. The system comprises at least one mobile device and an information processing station communicating with the mobile device. The information processing station comprises at least one logistics information server and at least one money flow information server. The logistics information server stores shipping status messages, and the money flow information server receives and stores the shipping status messages output from the logistics information server. After the money flow information server receives at least one trading message from mobile device on an encrypted channel, the trading message is directed on another encrypted channel with at least one encrypting protocol and an authorization message from one of bank servers is received. After the authorization message is encrypted, the authorization message is stored in correspondence with the shipping status messages and a delivery confirmation message is output to the logistics information server.

### PRIORITY CLAIM

The present application claims priority to Taiwan Patent Application No. 098125980, filed Jul. 31, 2009, and which is incorporated by reference in its entirety.

### FIELD OF THE INVENTION

The present invention relates to an information system, a processing station, and a credit card payment method, especially relates to an information system, a processing station, and a credit card payment method for transmitting information with a mobile device.

### BACKGROUND

With the growing e-Business trading amount, a lot of international credit card organizations provide safe credit card payment protocols to facilitate consumers to accept variable ways for payment, such as the payments on credit card, plastic money or debit card. For instance, the Visa International Service Association provides a 3D Secure protocol, and MasterCard International provides a Secure Payment Application (abbreviated SPA) protocol, Netscape provides a Secure Sockets Layer (abbreviated SSL) protocol, and the academic community also provides a KSL protocol. For the needs that the consumers want to pay on cash or credit card more conveniently, to develop a function of third party collections that can provide both credit card on delivery and cash on delivery for delivery systems is demanding.

However, people in the business of ordinary transportation and logistics industry often fail to establish a wireless payment platform that complies with both the credit card payment protocols adopted in each acquiring banks and relevant laws and regulations. Hence, when they adopt the second to the best way, i.e. use a wireless POS (point of sale) provided by banks for payment on credit card, they face a problem that the wireless POS provided by the banks cannot be integrated with the original goods delivery system used in the transportation and logistics industry. When goods are delivered to a consignee's address, the delivery man needs to operate two separate mobile devices belonging to different systems in order to complete the process of logging into the goods delivery system to update the delivery status of the goods and the credit card online authorization process.

It is obvious that the former dual-system structure needs to spend more cost to construct, and such structure often complicates the operation process for exchanging money flow information of the credit card online trading with numerous sequences and procedures. Therefore, an acceptable solution to solve these problems should be found.

### BRIEF DESCRIPTION OF THE DRAWINGS

FIG. 1 shows a prescriptive view of an information system according to the first embodiment of the present invention.

FIG. 2 shows a block diagram of a mobile device according to the first embodiment of the present invention.

FIG. 3 shows a block diagram of the money flow information server according to the first embodiment of the present invention.

FIG. 4 shows a prescriptive view of a format of the record files stored in the money flow information server according to the first embodiment of the present invention.

FIG. 5 shows a flow chart of a credit card payment method according to the first embodiment of the present invention.

FIG. 6 shows a prescriptive view of an information system according to the second embodiment of the present invention.

FIG. 7 shows a flow chart of a credit card payment method according to the second embodiment of the present invention.

### SUMMARY OF THE INVENTION

One of the objects of the present invention is to provide an information system, processing station, mobile device, and credit card payment method to establish a secured, wireless payment platform for confidential information.

Another object of the present invention is to provide an information system, processing station, mobile device, and credit card payment method to integrate the transmission and management of logistics information and money flow information.

According to the present invention, an information system that comprises at least one mobile device and an information processing station is provided. The information processing station is applied to enable the mobile device to communicate with at least one bank server; wherein the information processing station is comprised of at least one logistics information server and at least one money flow information server; wherein the logistics information server is applied to store a plurality of shipping status messages, and the money flow information server is applied to receive and store the at least one shipping status message from the logistics information server; wherein the money flow information server is comprised of a redirect module, an information storing module, an encryption/decryption module and a first controlling module connecting to the redirect module; wherein the information storing module and the encryption/decryption module are applied to control the operations of the redirect module, the information storing module and the encryption/decryption module; wherein the redirect module is applied to receive at least one trading message from an encrypted channel, and the encryption/decryption module enables the redirect module to direct the trading message to another encrypted channel and to receive an authorization message from a bank server with at least one encrypting protocol, wherein the authorization message is encrypted later and stored to the information storing module in correspondence with the shipping status message, and the redirect module transmits a delivery confirmation message to the logistics information server.

According to the present invention, an information processing station, which comprises at least one logistics information server and at least one money flow information server, is provided. The logistics information server is applied to store a plurality of shipping status message. The money flow information server is applied to receive and store at least one shipping status message from a logistics information server. The money flow information server is comprised of: a redirect module, an information storing module, an encryption/decryption module, and a first controlling module. The first controlling module is applied to connect to and control the redirect module, the information storing module and the encryption/decryption module. The redirect module is applied to receive at least one trading message from an encrypted channel, and the encryption/decryption module enables the redirect module to direct the trading message to another encrypted channel and to receive an authorization message from a bank server with at least one encrypting protocol. The authorization message is encrypted later and stored to the information storing module in correspondence with the shipping status message, and the redirect module transmits a delivery confirmation message to the logistics information server.

According to the present invention, it is provided a credit card payment method, comprising the steps of receiving and storing at least one shipping status message from at least one logistics information server; receiving at least one trading message from an encrypted channel and directing the trading message to another encrypted channel with at least one encrypting protocol; asking for authorization to a bank server; encrypting and saving the authorization message in correspondence with the shipping status message while receiving an authorization message; and transmitting a delivery confirmation message to the logistics information server.

The aforementioned logistics information server could be a route control system to manage the transportation and logistics processes, an E-tracking system for searching for goods delivery status, or a database system for storing logistics information. The shipping status message could comprise any type of information in the transportation and logistics procedures, such as information relating to goods delivery which may comprise a delivery date and an item number and preferably, the shipping status message may further comprise a delivery post code, a receipt post code, a mobile device number, a delivery man employee ID, and a shipper code, etc. The information storing module can save at least one record file to record the received shipping status message. The recorded file may comprise a delivery date and an item number, and in the preferred embodiment, the recorded file can further comprise an delivery post code, a receipt post code, a mobile device number, a delivery man employee ID and a shipper code.

The aforementioned encrypted channel is not limited to any kind or type of channels. For instance, it can be a combination of a wireless network, a virtual private network (VPN) and a wire network, such as a network connected with at least one fixed IP. The encrypting protocol is not limited to any kind or type of protocols, for the encrypting protocol may only depend on the safety level required for transmitting information and the interface adopted in the bank server to be communicated with. In some exemplary embodiments, for example, the encrypting protocol can be any combination of the SSL protocol, 3D protocol, SPA protocol, KSL protocol and other protocols. Not only the credit card number can be included in the trading message, other types of information, such as any combination of a credit card valid date, a transaction amount, a credit card security number, or a set of passwords, can also be included in the trading message. The credit card security number can be provided by an international credit card association, such as the CVV2 code provided by Visa International Service Association, and the CVC2 code provided by Master International, etc. Besides, a set of passwords can be a set of passwords registered in a credit card issuing bank.

The first controlling module can run at least one software, such as a browser software and/or a message transmitting interface server (Message Passing Interface Server, MPI Server) software to communicate with a bank server or a database server of an international association in an interface compatible with the credit card payment protocols adopted in the bank server.

Additionally, in an aspect of the present invention, an encryption/decryption module can be comprised to facilitate the encryption of the authorization message, which is the information to be stored to the information storing module When the information storing module reads out the encrypted authorization message, the encryption/decryption module can also carry out a decrypting process to restore the authorization message.

The mobile device may be comprised of an information inputting module, a wireless transmitting module, a storing module, a display module, a barcode reading module, and a second controlling module. The second controlling module connects the information inputting module, the wireless transmitting module, the storing module, the display module and the barcode reading module. The second controlling module may control the operation of the information inputting module, the wireless transmitting module, the storing module, the display module and the barcode reading module. In the second controlling module, it is preferable to run a browser operating system to direct the trading information to the bank servers through URL network address links. Therefore, when the information processing station enables the mobile device to communicate with a bank server, the mobile device can communicate with the bank server via a browser operating system to prevent it from storing the trading information in the mobile device.

The money flow information server can periodically gather statistics data in the information storing module for the authorization messages and transmitting at least one statistics data to at least one acquiring bank server for checking process. For example, to follow the current business culture, the money flow information server can transmit the statistics data, which may be extracted from daily authorization messages, such as the authorization trading total amount at a predetermined timing each day, to the bank server.

Hence, when the delivery man in the transportation and logistics business delivers goods to a consignee's address, he or she can use the information system, processing station, mobile device and credit card payment method of the present invention to adopt the encrypted channel that fits the encrypting protocol of the interface constructed in the bank server, transmit money flow information to the bank server and receives the authorization message from the bank server. According to this, the present invention can provide a wireless payment platform with a confidential mechanism and transmit the delivery confirmation message to the logistics information server to update the shipping status to integrate the transmission and management of the logistics information and money flow information.

### DETAILED DESCRIPTION OF THE INVENTION

The embodiments of the present invention are described below by referring to the attached drawings.

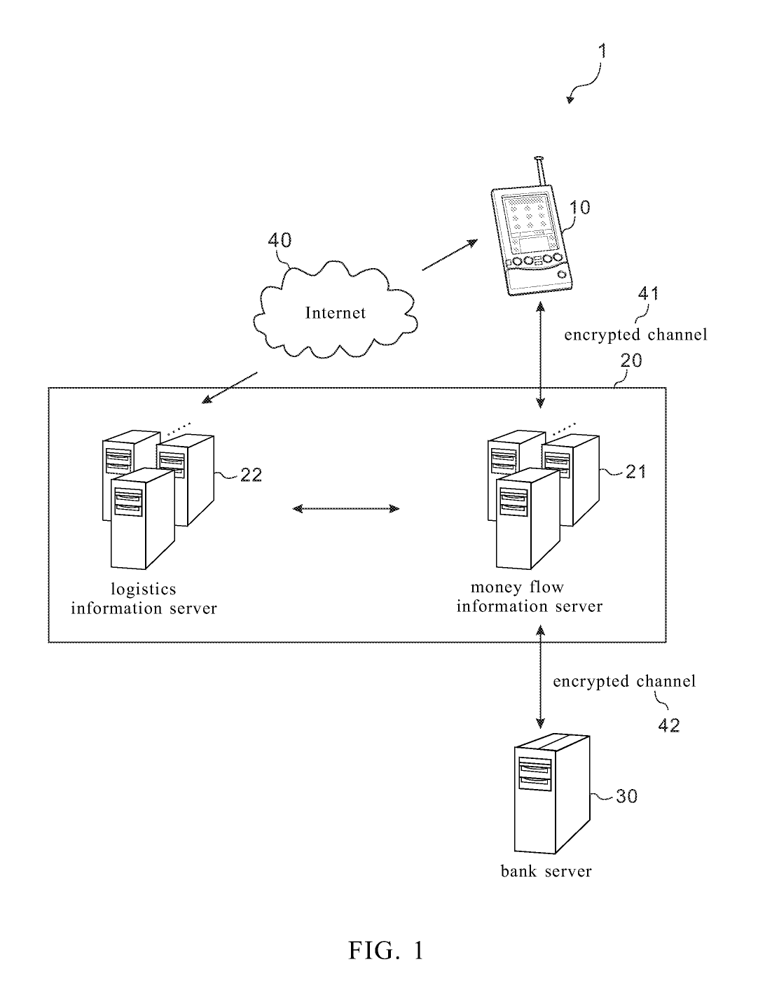

Please refer to FIG. 1, which shows an information system 1 of first preferred embodiment of the present invention. The information system 1 comprises at least one mobile device 10 and an information processing station 20 communicating with at least one bank server 30. In the FIG. 1, although only one mobile device10 and acquiring bank server 30 are shown, the quantity of the elements to be constructed in the embodiments of the present invention depends on the environment complexity to be implemented the merits of the present invention. For example, several mobile devices 10 and several bank servers 30 can be constructed in some embodiments of the present invention, without any limitation to the number. The information processing station 20 comprises at least one money flow information server 21 and at least one logistics information server 22. The logistics information server 22 stores a plurality of shipping status messages comprising a delivery date and an item number associated with goods delivery. The logistics information server 22 can communicate with the money flow information server 21. The quantity of the logistics information server 22 and money flow information server 21 are not limited, such as a plurality of logistics information server 22 or money flow information server 21 can duplicate the data saved in any one of the logistics information server 22 or money flow information server 21 to promote data reliability. The mobile device 10 constructs communication links with the money flow information server 21 and logistics information server 22 through a network channel 40 and an encrypted channel 41 to transmit the shipping status message and trading message respectively. The money flow information server 21 can direct the trading message to at least one bank server 30 via another encrypted channel 42 with at least one encrypting protocol to accomplish a credit card online authorization process.

The network channel 40 can be any kind of network communication media connected by a wireless network and/or wire network. The encrypted channel 41, and 42 can be any network communication media applied between approved communicating ends, such as a network of any combination of a wireless network, virtual private network, and wire network. In the present embodiment, the network channel 40 is a network communication media bridged by a wireless network of the 3G (3^{rd} Generation) system and a wire network, and the encrypted channel 41 is a network communication media bridged by a wireless network of the 3G system, virtual private network and a wire network of at least one set of fixed IP. Only approved mobile device 10 and money flow information server 21 can proceed communication on the encrypted channel 41. The encrypted channel 41 is a direct line with a set of fixed IP dedicated to the money flow information server 21 and other approved shop to communicate with the acquiring bank server 30.

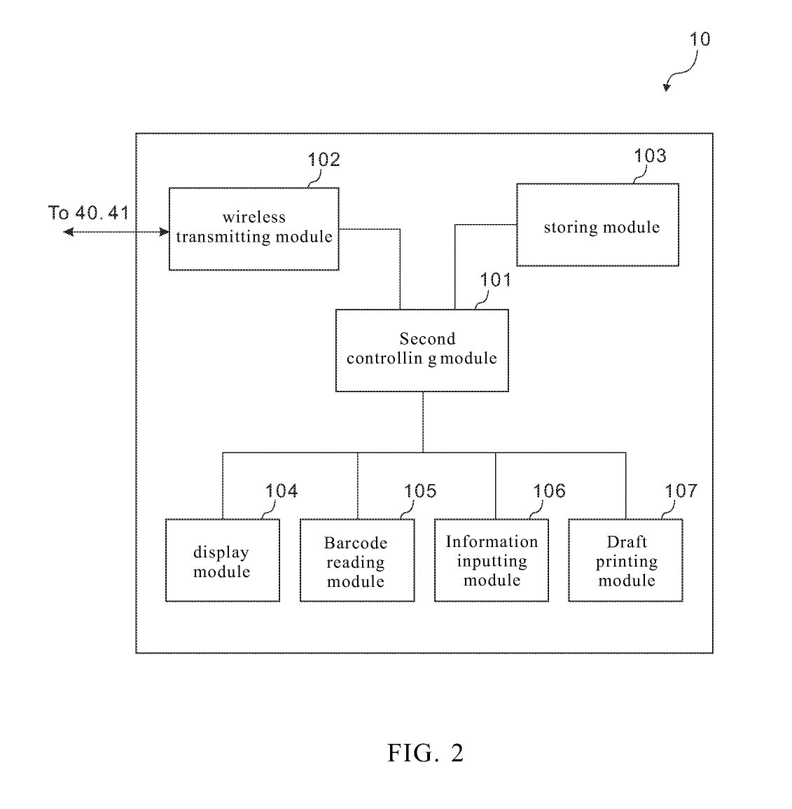

Please refer to both FIG. 2 and FIG. 1, wherein FIG. 2 shows a block diagram of the mobile device 10 of the present embodiment. As shown, the mobile device 10 comprises a second controlling module 101, a wireless transmitting module 102, a storing module 103, a display module 104, a barcode reading module 105, an information inputting module 106, and a draft printing module 107. The second controlling module 101 connects the wireless transmitting module 102, storing module 103, display module 104, barcode reading module 105, information inputting module 106, and draft printing module 107 to control the operation of the modules connected thereto. The detailed illustrations for the operation of the each modules are as followed.

In the present embodiment, the mobile device 10 is preferably provided for people, especially the delivery men, in the transportation and logistics industry. The second controlling module 101 runs a browser operating system, for example, the windows OS of Microsoft corporation or the Safari browser of Apple Inc., etc. One function of the mobile device 10 is to allow the delivery man to receive the goods. For instance, he or she can scan an item number in the form of barcode marked on the goods with the barcode reading module 105, and then an electrical signal is transformed to be transmitted to the second controlling module 101 accordingly. The second controlling module 101 controls the wireless transmitting module 102 to transmit a wireless signal to Internet 40 for logging-in to the logistics information server 22, and a wireless signal representing the electrical signal for downloading related shipping status messages of the item number to be saved to the storing module 103. The wireless transmitting module 102 comprises an infrared ray transceiver and a wireless transmitting transceiver, such as a 3G transceiver. On the display module 104, the received shipping status messages can be shown. The shipping status messages may comprise a delivery date, delivery post code and goods delivery type for example. The delivery date is the date the people of the transportation and logistics industry receive an order for delivery of goods. The delivery post code is a code for a delivery post. The goods delivery type is a code or some letters that indicate whether a credit card on delivery service is required. Hence, when a delivery man delivers goods, he or she can know whether a credit card on delivery service is required upon delivery.

Another function of the mobile device 10 is for the delivery man to input trading messages by operating the information inputting module 106, for the money flow information server 21 to direct to the acquiring bank server 30 when a goods delivery type represents “credit card on delivery”. The bank server 30 will confirm whether this trading is authorized. In the present embodiment, the information inputting module 106 comprises a keypad comprising a plurality of keys for ciphers, an enter key and a cancel key. However, the information inputting module 106 can be other type of keypads, touch panels capable to identify writing, or other human interface device to establish a human-device interface. When receiving the authorization message provided by the acquiring bank server 30, the draft printing module 107 can print out a draft comprising the authorization message, which will be signed by the credit card owner, and a check sheet that can be kept by transportation and logistics company. The paragraphs below will illustrate the related process for credit card online in a detailed manner.

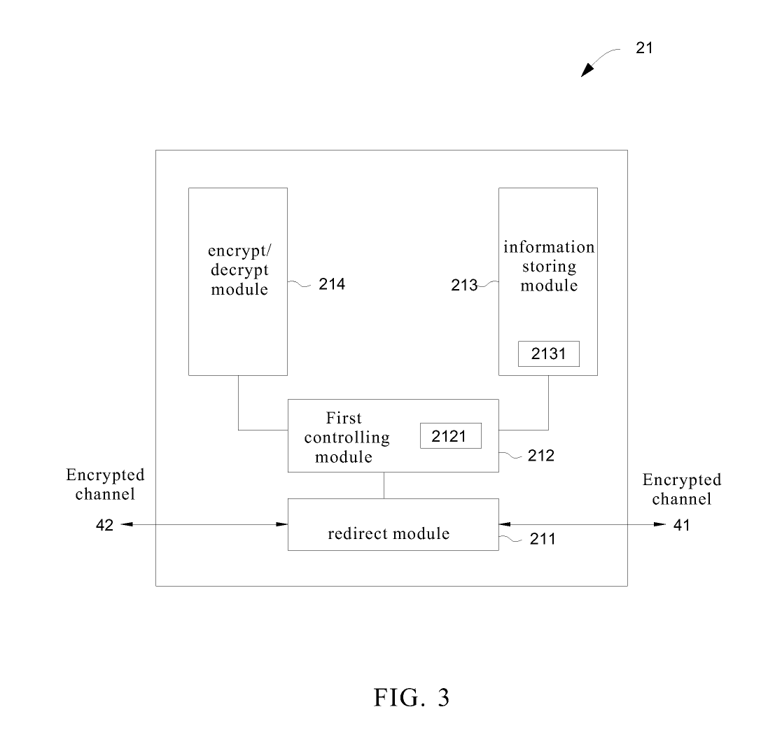

Please refer to FIG. 3, where a block diagram of the money flow information server 21 of the present embodiment is shown. The money flow information server 21 comprises a redirect module 211, a first controlling module 212, an information storing module 213 and an encryption/decryption module 214. The information storing module 213, encryption/decryption module 214 and redirect module 211 all connect to the first controlling module 212 to accept the control of the first controlling module 212. In the information storing module 213, it is stored at least one record file 2131. The first controlling module 212 runs at least one software 2121 to assist the money flow information server 21 to establish an environment by using a common interface for communicating with acquiring bank server 30. Therefore, with the redirect module 211 and money flow information server 21, the communication between mobile device 10 and acquiring bank server 30 is enabled by constructing a communication link between mobile device 10 and acquiring bank server 30 on the encrypted channels 41, 42.

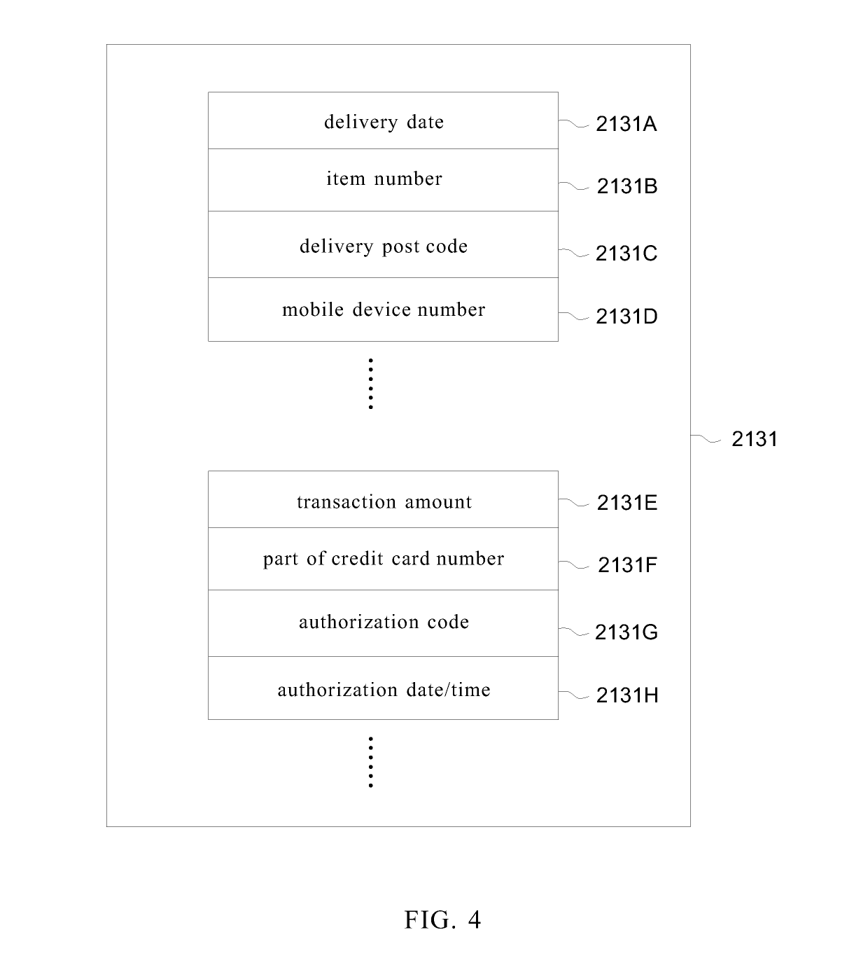

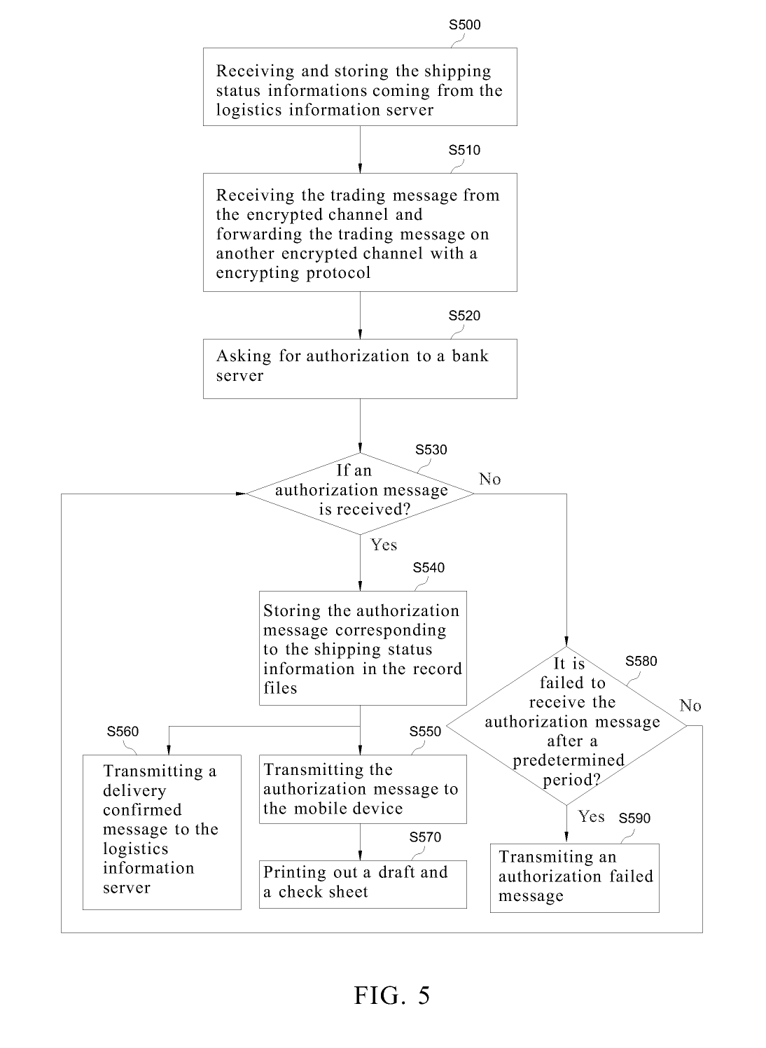

Please refer to FIG. 2, FIG. 3, FIG. 4 and FIG. 5 to understand an exemplary embodiment of the credit card online related process according to the present invention. FIG. 4 shows an embodiment of the record file format for the money flow information server to store information. FIG. 5 shows a flow chart of the credit card payment method of the present embodiment. The logistics information server 22 will screen the shipping status message stored and only transmit the shipping status messages whose goods delivery type is of credit card on delivery to the money flow information server 21. The money flow information server 21 receives and stores these shipping status messages coming from the logistics information server 22 (step S500). In the present embodiment, the money flow information server 21 saves these shipping status messages according to a predetermined format of the record files 2131. For example, in the record files 2131, it is comprised of some fields for storing the shipping status messages. These fields may include a field for delivery date 2131A, a field for item number 2131B, a field for delivery post code 2131C and a field for mobile device number 2131D, etc. However, in some other examples, the fields may further include a field for shipper code, a field for delivery man employee ID and/or a field for shop code. The encryption/decryption module 214 can encrypt the record files 2131 to transform the information stored in the information storing module 213 to ciphertext and transform the encrypted record files 2131 to plaintext before reading out the information.

When one package of the goods is delivered to the place of the consignee and proceeded a credit card online payment procedure, the delivery man would first use the information inputting module 106 to choose a payment on credit card function to establish a communication link to an acquiring bank server 30 with an URL link formed by the browser. At this time, the mobile device 10 will transmit the item number of the goods and a trading frame requiring command to the money flow information server 21. The money flow information server 21 will confirm whether the source address of the trading frame requiring command matches the information filled in the field of the mobile device number 2131D. If the money flow information server 21 confirms that the information is matched, a request for the credit card trading frame would be issued to the acquiring bank server 30 and directed to the mobile device 10. At this time, the consignee can key in a trading message in this trading frame shown on the display module 104, and the money flow information server 21 receives the trading message from the encrypted channel 41 and directs the trading message on the encrypted channel 42 with a encrypting protocol (step S510). The message format transmitted on the encrypted channel 41 complies with one or more encrypting protocols, such as Secure Sockets Layer (SSL) protocol. The encryption/decryption module 214 also encrypts the trading message received from the encrypted channel 41 to transform its format to fit the encrypting protocol. Then, the encrypted trading message is directed to the acquiring bank server by the redirect module 211. As the mobile device 10 directly logs-in to a website with a browser operating system and the money flow information server 21 merely charges with the redirection and transmission associated procedures for the trading message after encryption, the trading message will not be kept in the mobile device 10 or money flow information server 21. The trading message comprises different types of information, such as a credit card number, a credit card valid date, a transaction amount, a CVV2 (Card Verification Value 2) security number provided by VISA International Service Association, or a CVC2 (Card Validation Code 2) security number provided by MasterCard International, depending on the credit card association that issues the credit card.

After the trading message is directed, the first controlling module 212 runs at least one software 2121 to ask for the authorization to a bank server 30 (step S520). In the present embodiment, it is the acquiring bank server 30 that requests authorization to the bank that issues the credit card. Later, it would determine whether an authorization message is received (step S530). The authorization message can comprise different types of messages, such as a transaction amount, a part of the credit card number, an authorization code, an authorization date and time, etc, depending on the bank. When the authorization message is received, the money flow information server 21 stores the authorization message in the information storing module in correspondence with the shipping status message in the record files 2131 (step S540). For example, after the money flow information server 21 encrypts the authorization message with the encryption/decryption module 214, the authorization message in correspondence with the item number 2131B is filled into the fields of the transaction amount 2131E, part of credit card number 2131F, authorization code 2131G, authorization date and time 2131H of a record file 2131 which is for saving the item number.

Then, the redirect module 211 transmits the authorization message to the mobile device 10 (step S550). Later, the draft printing module 107 of the mobile device 10 prints out a draft and a check sheet (step S570). After step S540, the money flow information server 21 also transmits a delivery confirmation message to the logistics information server 22 (step S560). The logistics information server 22 can update the shipping status message for the item number according to the delivery confirmation message. For instance, the status can be updated to “delivered”. In the present embodiment, although it is exemplified as proceeding step S550 and step S560 synchronously after step S540, the proceeding sequence of step S540, step S550 and step S560 is not limited to this example. Other sequences with different order are acceptable in some other embodiments.

Besides, if the money flow information server 21 determines that it is failed to receive the authorization message after a predetermined period (step S580), the money flow information server 21 will transmit an authorization failed message to the mobile device 10 (step S590). For aligning with the daily balance statement in the current e-Business culture, the money flow information server 21 of the present embodiment can also periodically, such as at a predetermined time daily gather a batch of statistics data for the authorization messages stored in the information storing module 213 and transmit the statistics data to the bank server 30. The statistics data can comprise an daily accumulated total amount for all authorization trading for each issuing banks to facilitate the acquiring bank, issuing bank and the people in the transportation and logistics can proceed funding process.

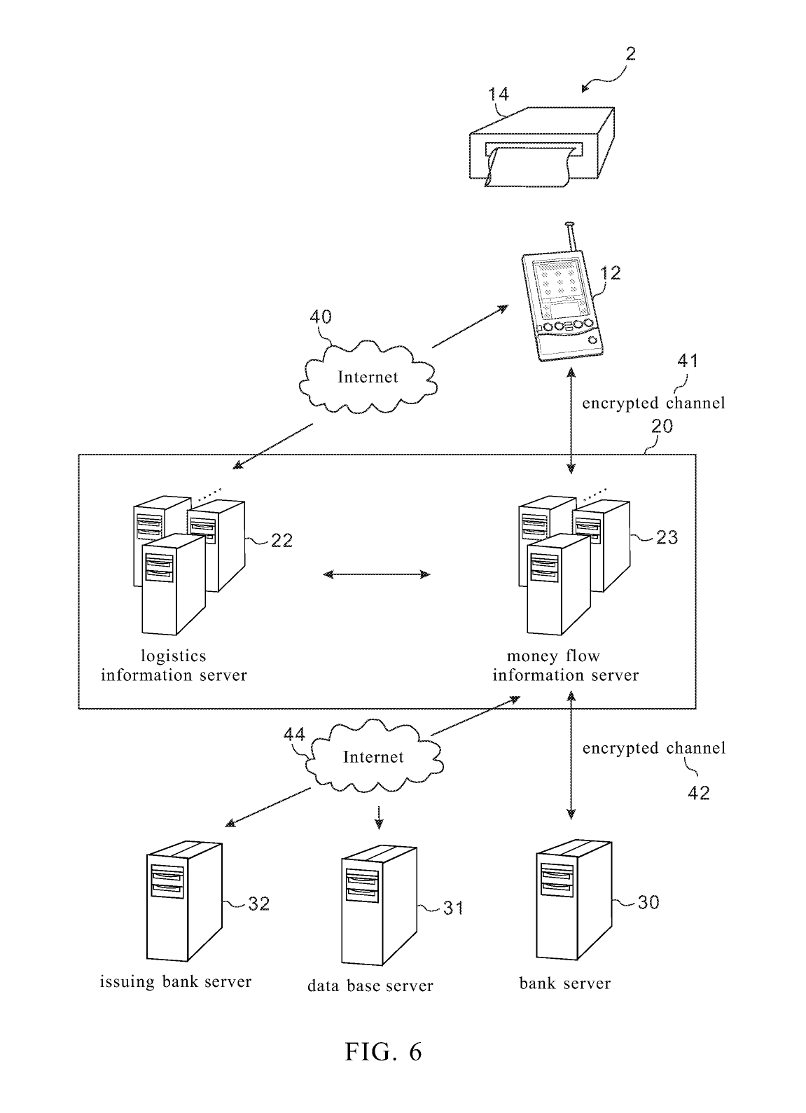

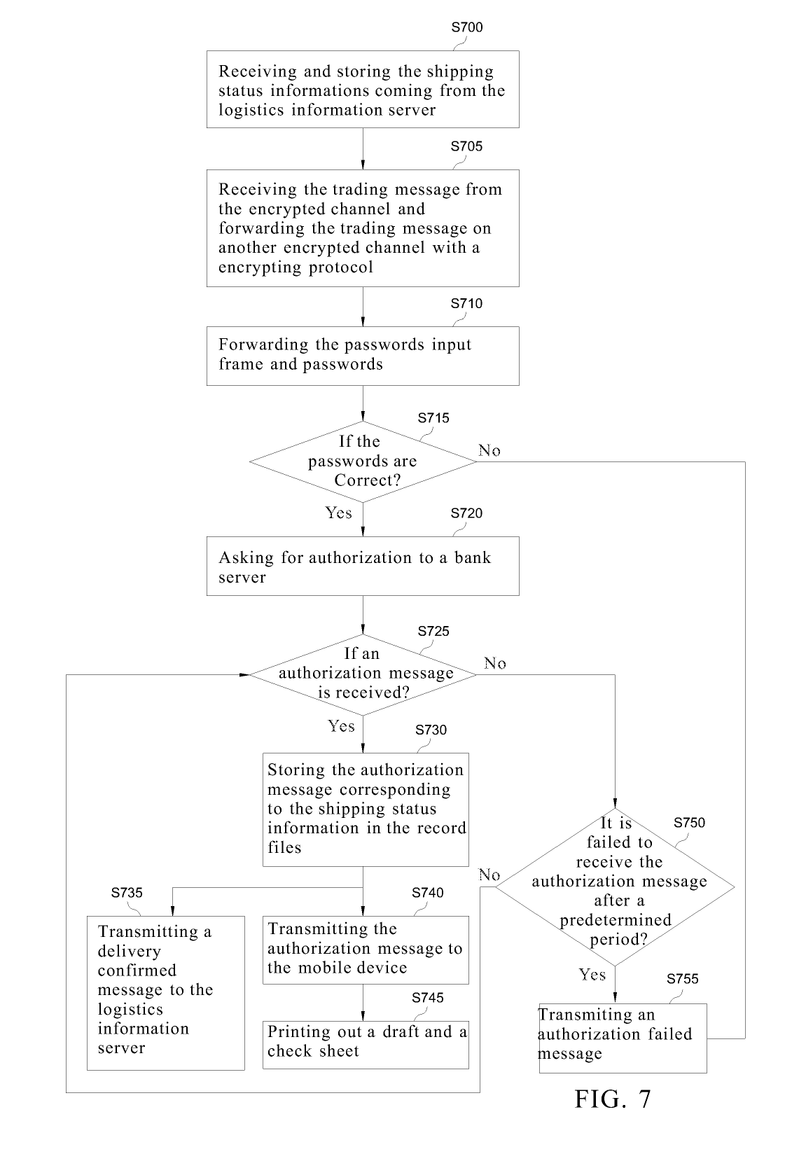

Please refer to FIG. 6 and FIG. 7. FIG. 6 shows a prescriptive view of an information system in the second embodiment according to the present invention. FIG. 7 shows a flow chart of a credit card payment method in the second embodiment according to the present invention. In order to illustrate the present embodiment clearly, the difference between the present embodiment and the first embodiment should be emphasized here. In the present embodiment, the 3D protocol is used to assist the credit card authorization procedure. The mobile device 12 of the present embodiment is about the same as the mobile device 10 illustrated in the first embodiment. However, the mobile device 12 is not positioned a draft printing module 107 as the mobile device 10. Firstly, the information system 2 of the present embodiment further comprises a draft printing device 14 to receive the authorization messages transmitted by the mobile device 12 through the wireless communication to print out the drafts. Secondly, the software runs by the money flow information server 23 of the present embodiment further comprises a message passing interface server software (MPI Server software) to assist the credit card authorization process to fit the 3D protocol. The differences between the credit card authorization process of the present embodiment and that of the former embodiment are mainly in the steps S705, S710 and S715 in FIG. 7. In step S705, the MPI Server software will transmit the trading message received via the encrypted channel 41 to a database server 31, such as VISA internet directory (Visa Directory) and a issuing bank server 32 the credit card belonging to through the network channel 44, such as Internet, to determine if this credit card has been registered for 3D Secure service. If the credit card has been registered for 3D Secure service, the MPI Server software will redirect the browser of the mobile device 12 to the domain of the issuing bank. At this time, the MPI Server software will direct the passwords input frame from the issuing bake domain to the mobile device 12 to allow a window popping-up on the display module 104. In the shown window, it may ask the credit card owner to key in a set of passwords. After the credit card owner inputs the passwords, the MPI Server software will direct the passwords output by the mobile device 12 to the issuing bank server 32 (step S710). If the issuing bank server 32 determines that the passwords are correct, it will transmit the authorization code to the acquiring bank server 30 (step S715). The MPI Server software will request an authorization to the acquiring bank server 30 to receive an authorization message comprising the authorization code (step S720).

Although when the passwords is determined as wrong, the flow will directly goes to the step S755 to transmit an authorization failure message in the present embodiment, in the other embodiments according to the present invention, other flows can be adopted to allow the money flow information server 23 to use other ways to request the trading authorization, such as requesting the trading authorization by the security number, such as the CVV2 or CVC2 codes as disclosed in the first embodiment.

Therefore, according to the aforesaid illustration, it is known that when a delivery man of the transportation and logistics business delivers goods to the consignee's address, he or she can use the information system, processing station and credit card payment method of the present invention to transmit the money flow information to the bank server via the encrypted channels to fit the encrypting protocol used in the interface of the bank server and received the authorization message. A secured wireless payment platform for confidential information is provided to the consignee. Furthermore, as the shipping status message can be transmitted to the logistics information server via the network channel for updating, the transmission and management of the logistics information and money flow information can be integrated.

The foregoing is considered as illustrative only of the principles of the present invention. Further, as numerous modifications and changes will readily occur to those skilled in the art, it is not desired to limit the invention to the exact construction and applications shown and described. Accordingly, all suitable modifications and equivalents may be regarded as falling within the scope of the invention in the appended claims and their equivalents.

What is claimed:

1. An information system, comprising:
at least one mobile device, and
an information processing station, which is applied to enable the mobile device to communicate with at least one bank server; wherein the information processing station is comprised of at least one logistics information server and at least one money flow information server; wherein the logistics information server is applied to store a plurality of shipping status messages, and the money flow information server is applied to receive and store the at least one shipping status message from the logistics information server; wherein the money flow information server is comprised of a redirect module, an information storing module, an encryption/decryption module and a first controlling module connecting to the redirect module; wherein the information storing module and the encryption/decryption module are applied to control the operations of the redirect module, the information storing module and the encryption/decryption module;
wherein the redirect module is applied to receive at least one trading message from an encrypted channel, and the encryption/decryption module enables the redirect module to direct the trading message to another encrypted channel and to receive an authorization message from a bank server with at least one encrypting protocol, wherein the authorization message is encrypted later and stored to the information storing module in correspondence with the shipping status message, and the redirect module transmits a delivery confirmation message to the logistics information server.

2. The information system as claim 1, wherein the first controlling module runs a message transmitting interface server software to communicate with the at least one bank server.

3. The information system as claim 1, wherein the mobile device is comprised of:
an information inputting module;
a wireless transmitting module;
a storing module;
a display module;
a barcode reading module; and
a second controlling module, which is connected to and applied to control the information inputting module, the wireless transmitting module, the storing module, the display module and the barcode reading module.

4. The information system as claim 3, further comprising a draft printing device to receive at least one printed information wireless-transmitted by the mobile device.

5. The information system as claim 1, wherein the encrypted channels are of any combinations of wireless network, virtual private network and wire network.

6. The information system as claim 1, wherein the encrypted channels are by way of at least one fixed IP.

7. The information system as claim 1, wherein the encrypting protocol is a SSL protocol, 3D protocol or SPA protocol.

8. The information system as claim 1, wherein the trading message is comprised of any combination of a credit card number, a credit card valid date, a transaction amount, a set of security number and a set of passwords.

9. The information system as claim 1, wherein the information storing module stores at least one record file to record the received shipping status message, wherein the record file is comprised of a delivery date and an item number.

10. The information system as claim 1, wherein the logistics information server is applied to update the corresponding shipping status message according to the delivery confirmation message.

11. The information system as claim 1, wherein the mobile device communicates with the bank server via a browser operating system when the information processing station enables the mobile device to communicate with the at least one bank server.

12. A credit card payment method, comprising the steps of:
receiving and storing at least one shipping status message from at least one logistics information server;
receiving at least one trading message from an encrypted channel and directing the trading message to another encrypted channel with at least one encrypting protocol;
asking for authorization to a bank server;
encrypting and saving the authorization message in correspondence with the shipping status message while receiving an authorization message; and
transmitting a delivery confirmation message to the logistics information server.

13. The credit card payment method as claim 12, wherein the encrypted channels are of any combinations of a wireless network, virtual private network and wire network.

14. The credit card payment method as claim 12, wherein the encrypted channels are by way of at least one fixed IP.

15. The credit card payment method as claim 12, wherein the encrypting protocol is a SSL protocol, 3D protocol or SPA protocol.

16. The credit card payment method as claim 12, further comprising a step of running a message transmitting interface server software to communicate with at least one bank server.

17. The credit card payment method as claim 12, further comprising a step of transmitting the authorization message to a mobile device.

18. The credit card payment method as claim 12, wherein the trading message comprises any combination of a credit card number, a credit card valid date, a transaction amount, a set of security number and a set of passwords.

19. The credit card payment method as claimed in the claim 12, wherein the shipping status message comprises a delivery date and an item number.

20. An information processing station, comprising:
at least one logistics information server, which is applied to store a plurality of shipping status messages; and
at least one money flow information server, which is applied to receive and store at least one shipping status message from a logistics information server; wherein the money flow information server is comprised of:
a redirect module;
an information storing module;
an encryption/decryption module; and
a first controlling module, which is applied to connect to and control the redirect module, the information storing module and the encryption/decryption module;
wherein the redirect module is applied to receive at least one trading message from an encrypted channel, and the encryption/decryption module enables the redirect module to direct the trading message to another encrypted channel and to receive an authorization message from a bank server with at least one encrypting protocol, wherein the authorization message is encrypted later and stored to the information storing module in correspondence with the shipping status message, and the redirect module transmits a delivery confirmation message to the logistics information server.

21. The information processing station as claim 20, wherein the money flow information server periodically gathers statistics of the authorization message in the information storing module and transmits at least one batch of statistics data to an acquiring bank server.
